(19) United States
(12) Patent Application Publication
(10) Pub. No.: US 2002/0059463 A1
(43) Pub. Date: May 16, 2002

(54) Method and system for accelerating internet access through data compression

(76) Inventor: Leonid Goldstein, Costa Mesa, CA (US)

Correspondence Address: Patent Law & Venture Group, 3151 Airway Ave., Suite K -105, Costa Mesa, CA, 92626, US

(21) Appl. No.: 09/903,053

(22) Filed: Jul. 10, 2001

Related U.S. Application Data
(60) Provisional application No. 60/246,907, filed on Nov. 10, 2000.

(51) Int. Cl. G06F 15/16

(52) U.S. Cl. 709/247; 709/203

(57) ABSTRACT

A computer system and method uses a client computer providing a browser and a decompression module, at least one compression proxy comprising a CPU, a memory device, device for sending requests, device for receiving requests, device for sending data, device for receiving data, and data compression device, and a server, the client computer, compression proxy and server, is interconnected through a wide area network, with the compression proxy further interconnected to a user database. The method comprises the steps of receiving requests for data from a client computer, checking authorization of the requests for data, rejecting unauthorized requests for data, sending authorized requests for data to a server, receiving data from the server, checking if the data are suitable for compression, sending unsuitable data to the client computer, compressing data suitable for compression, sending compressed data to the client computer.

We claim the priority date of a prior filed provisional patent application having Ser. No. 60/246,907 and an official filing date of Nov. 10, 2000 and which discloses substantially the same material as described herein.

### BACKGROUND OF THE INVENTION

Field of the Invention

This invention relates generally to computer system and method of handling data, and more particularly to a computer system and method for gaining access to the Internet more rapidly by using data compression teehniques.

Description of Related Art

The following art defines the present state of this field:

Kralowetz, et al., U.S. Pat. No. 5,657,452 describes A method for efficiently setting up a data transmission session over a communication channel between a local endpoint application and a network endpoint application with a proxy engine in a manner that is transparent to the user. The proxy engine is placed in simultaneous communication sessions with the local endpoint application and the network endpoint application. The proxy engine determines the network control protocols that are supported by both the network endpoint application and the local endpoint application. The proxy engine enables the network control protocols that are supported by both the network endpoint application and the local endpoint application. Optionally, the proxy engine enables data compression techniques that are supported by both the network endpoint application and the proxy engine. After the network control protocols and data compression techniques (if desired) are enabled, the proxy engine transmits data between the local endpoint application and the network endpoint application over the communication channel.

Bhide, et al., U.S. Pat. No. 5,852,717 describes Systems and methods of increasing the performance of computer networks, especially networks connecting users to the Web, are provided. Performance is increased by reducing the latency the client experiences between sending a request to the server and receiving a response. A connection cache may be maintained by an agent on the network access equipment to more quickly respond to request for network connections to the server. Additionally, the agent may maintain a cache of information to more quickly respond to requests to get an object if it has been modified. These enhancements and other described herein may be implemented singly or in conjunction to reduce the latency involved in sending the requests to the server by saving round-trip times between computer network components.

Compression proxy server: Design and Implementation, by Chi-Hung Chi et al, teaches that automatic data compression in the web proxy server is an important mechanism that can potentially reduce network bandwidth consumption and web access latency significantly. However, unlike traditional data compression, web protocols and data have unique characteristics that make compression challenging. These include data block streaming, wide range of data object sizes and types, and real-time response. In this paper, we focus on automatic web data compression in the HTTP proxy server. A new classification of web data compression based on system complexity and HTTP requirements is proposed: stream, block and file compression. Then the concept of hybrid web data compression is introduced. To understand the potentials of web data compression better, an implementation of the proposed hybrid compression in the Squid proxy server is described. The result is very promising as about 30% of the bandwidth can be saved easily. Furthermore, even with a low end Pentium 266 MHz PC as the proxy machine the compression overhead is less than 1% of the transfer time.

Netsetter.com information sheet dated Jun. 5, 2001.

The prior art teaches the use of data compression but does not teach the present system and method for using compression for improved access speed to the internet.

### SUMMARY OF THE INVENTION

The present invention teaches certain benefits in construction and use which give rise to the objectives described below.

A computer system and method uses a client computer providing a browser and a decompression module, at least one compression proxy comprising a CPU, a memory device, device for sending requests, device for receiving requests, device for sending data, device for receiving data, and data compression device, and a server, the client computer, compression proxy and server, is interconnected through a wide area network, with the compression proxy further interconnected to a user database. The method comprises the steps of receiving requests for data from a client computer, checking authorization of the requests for data, rejecting unauthorized requests for data, sending authorized requests for data to a server, receiving data from the server, checking if the data are suitable for compression, sending unsuitable data to the client computer, compressing data suitable for compression, sending compressed data to the client computer.

A primary objective of the present invention is to provide an apparatus and method of use of such apparatus that provides advantages not taught by the prior art.

Another objective is to provide such an invention capable of accelerated Internet access.

A further objective is to provide such an invention capable of providing service to users independently from the ISP.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of a preferred embodiment of the invention;

FIG. 2 is a block diagram showing further details thereof.

FIG. 3 is a flow diagram thereof defining operations of a proxy computer;

FIG. 4 is a flow diagram thereof defining operations of an authorization method thereof; and

FIG. 5 is a block diagram of a further preferred embodiment of the invention.

### DETAILED DESCRIPTION OF THE INVENTION

The above described drawing figures illustrate the invention in at least one of its preferred embodiments, which is further defined in detail in the following description.

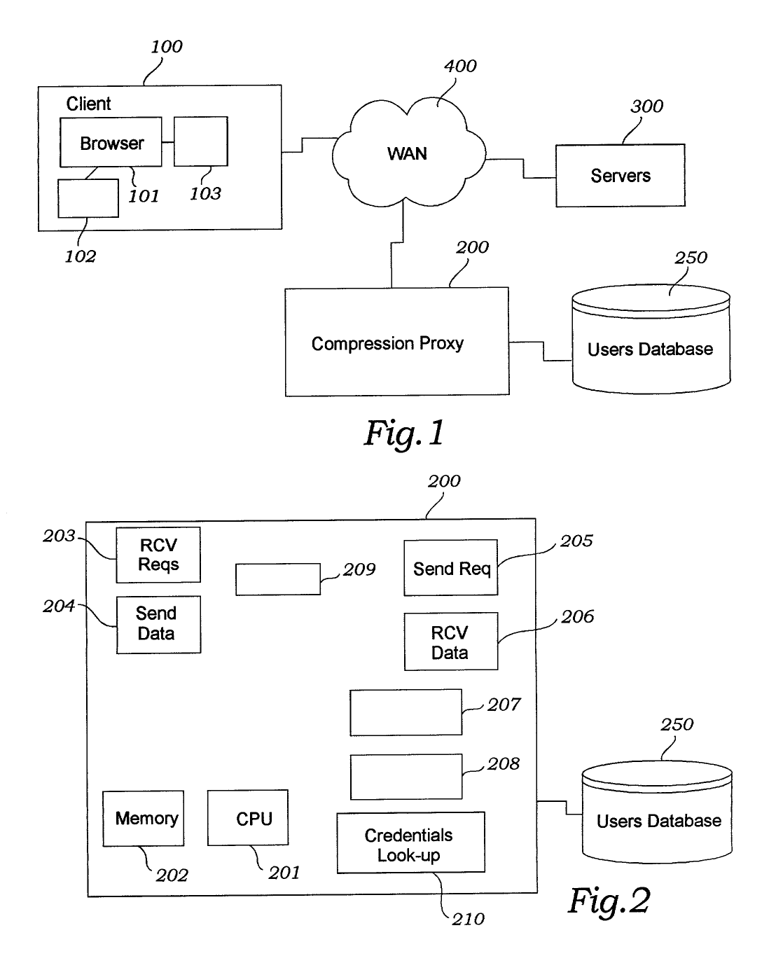

FIG. 1 depicts a distributed computer system according to the invention. A client computer 100 (client), comprising a browser 101, is connected to a wide area network 400 (WAN). The client comprises a decompression module 102 having certain well known compressed data formats, and is preferably a part of the browser 101. In one embodiment, the client includes an additional software module 103, containing any well known means for transformation of data requests from the browser and providing responses. Such transformation functions includes: decompression of response data, attaching credentials and request routing. At least one proxy computer system 200 (compression proxy or proxy) is connected to the WAN 400. Also, there is a plurality of servers 300 (server) connected to the WAN 400 and it is enabled to respond to data requests. The client 100 is configured in such a way, that at least some data requests it sends to the server 300 are routed through the proxy 200.

A preferred embodiment of the client is an IBM compatible PC, running Netscape Navigator 4.75 or Microsoft Explorer 5.0 (IE5), connected to the Internet. Another example is a wireless device having an Internet browser of any type. The above mentioned decompression module 102 is present in both Netscape Navigator 4.75 and Microsoft Explorer 5.0. It is designed to decompress data in format GZIP, described in RFC 1952. An optional module can take the form of a Netscape plug-in. The preferred protocol for the data requests and responses is HTTP, working over a TCP/IP stack. For the description of the HTTP 1.1 protocol see RFC 2616. The WAN 400 is preferably the Internet.

IE5 can be configured to send the data requests through proxy 200 using a proxy autoconfiguration file. Another method of configuration is a manual configuration; i.e., launching IE5, selecting the “Tools/Internet Options . . . ” menu item, and when a dialog box appears pressing the “LAN Settings . . . ” button in the “Connections” tab and checking “Use a proxy server” checkbox and then entering its address.

Now referring to FIG. 2. The proxy 200 has CPU 201, first memory 202, a means for receiving data requests 203, a means for sending data 204, a means for sending data requests 205, and a means for receiving data 206. Such means for our preferred embodiment usually comprise a well known network card and software, implementing TCP/IP and HTTP protocols. This is very well known in the field of this invention.

Further, proxy 200 has a means for data compression. An example of a compression format is GZIP, but other data compression formats can be used equally as well. Preferably, the compression should be loss-less, but in some cases, the proxy 200 can employ means to “understand” the application level protocol and to compress data with informational loss, but where decompressed data is not “different” from the original data from the point of view of the application. The proxy 200 includes a means to determine whether a particular data is suitable for compression and if it is, by which method. For example, non-encrypted textual and mark up files are suitable for compression using GZIP and other general data compression techniques. In this particular embodiment the decision whether to compress particular data may is made, in this invention, by any combination of the following:

based on the protocol: http is suitable for compression, https is not;

based on the request, in response to which the data was sent: the requests ending with “.htm,” “html,” “asp,” “.css,” “.xml,” “/,” or having question a mark “?”and not containing “.gif” or “.jpg” bring data, in most cases suitable for compression;

based on the HTTP header for the request: respons to requests, accepting “text/html” type are suitable for compression; and

based on the HTTP header of the response, especially its media-type: if the media-type is “text/html”, the data is suitable for compression.

Further, the proxy 200 is connected to a database of users 250. Such a database preferably resides in a permanent storage of the proxy or alternately, the proxy is connected to it through a network. Microsoft SQL Server is preferably used as a database engine. Alternatively, a RADIUS server is used instead of a database engine. In order to increase performance, a credentials lookup table 210 may be established in the memory of the proxy server.

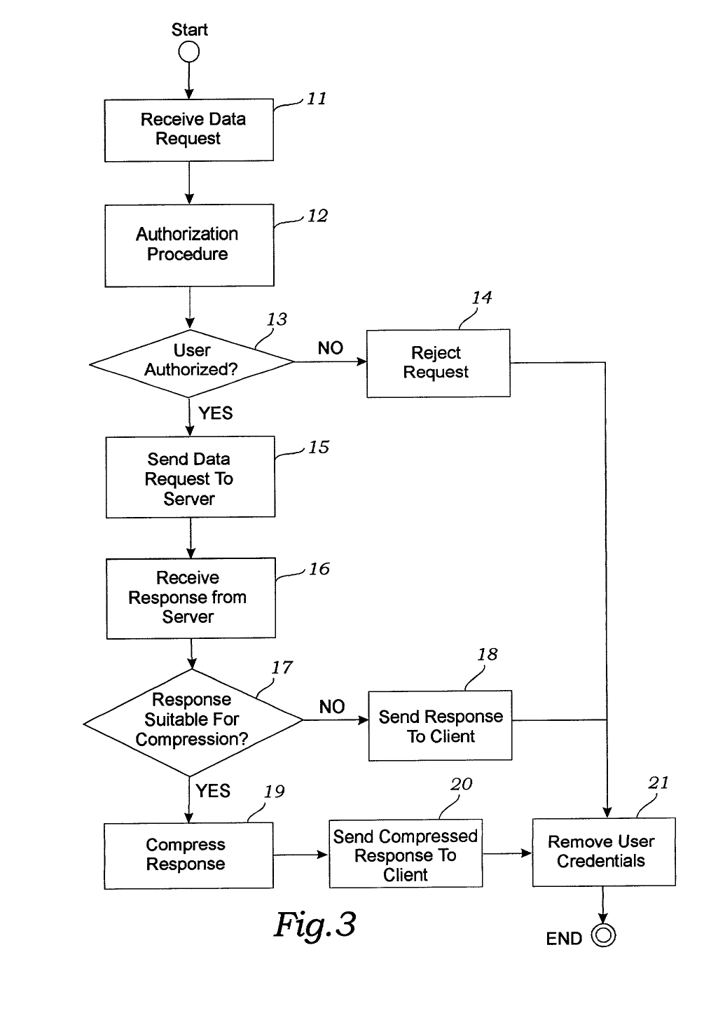

Let us proceed to the operation of the invention. See FIG. 3, which shows how the proxy 200 serves a client request. The proxy 200 receives a user request in Step 11. Then, the proxy 200 checks, whether the user is authorized to use the proxy 200. The authorization procedure 12, efficient for a large number of users, is described below. If the user is not authorized, the request is rejected. If the user is authorized, the proxy 200 forms a request to the server 300, and waits for a response. In the preferred embodiment, the proxy 200 will change the request from the client according to the HTTP requirements to proxies. When the proxy 200 receives the response from the server 300, it checks (test 17), whether the received data is suitable for compression. This check can be done with any combination of the means, described above. If it is found unsuitable, the proxy sends the response data to the client without compression (step 18). If it is found suitable, the proxy compresses it (step 19) and then sends it to the client (step 20). If the response is long, its data may be divided in parts of a predetermined size and compressed and sent to the client in parts, rather than waiting until the fill response is received. This protocol is well known and used broadly.

The records of the database 250 preferably contains the fields: Credentials, which is used for authorizing requests from the clients, and User, which is used by the system for updating subscription information. The database 250 should perform at least three operations: Add User, Delete User, and Look up Credentials, but may perform other operations as necessary.

In the authorization procedure, the authorization mechanism from RFC 2617 is preferrably used. Specifically, the client sets its credentials in the Proxy-Authorization field in response to HTTP value 407 (Proxy Authentication Required), as required by RFC 2617. In another embodiment, the proxy redirects the client to an Internet web page, specifically established to accept user credentials. The client keeps the user credentials in a cookie and retrieves and sends it when it is directed or redirected to the web page. Alternately, the client lets the user enter it at the beginning of each session. In another embodiment, the web page, accepting credentials, is set as a home page for the browser 101, so the browser retrieves the credentials from the cookie and sends it to the web page each time the user launches the browser. The server, processing the initial authorization, is physically separate from the compression proxy 200 and is connected to it through a network or the proxy is integrally formed therewith. After the user credentials are received, the proxy 200 or the authorization server queries the database and checks, whether the user is registered in the database and authorized to use the service. In order to accelerate user authorization, a credentials lookup table 210, containing a majority of the credentials of the authorized users, is established in the memory of the proxy 200. It is created from the database when the proxy 200 starts and is updated occasionally (for example, once in a day). When the lookup table is present, the proxy 200 searches it first. If the user is not found, the proxy 200 queries the database 250.

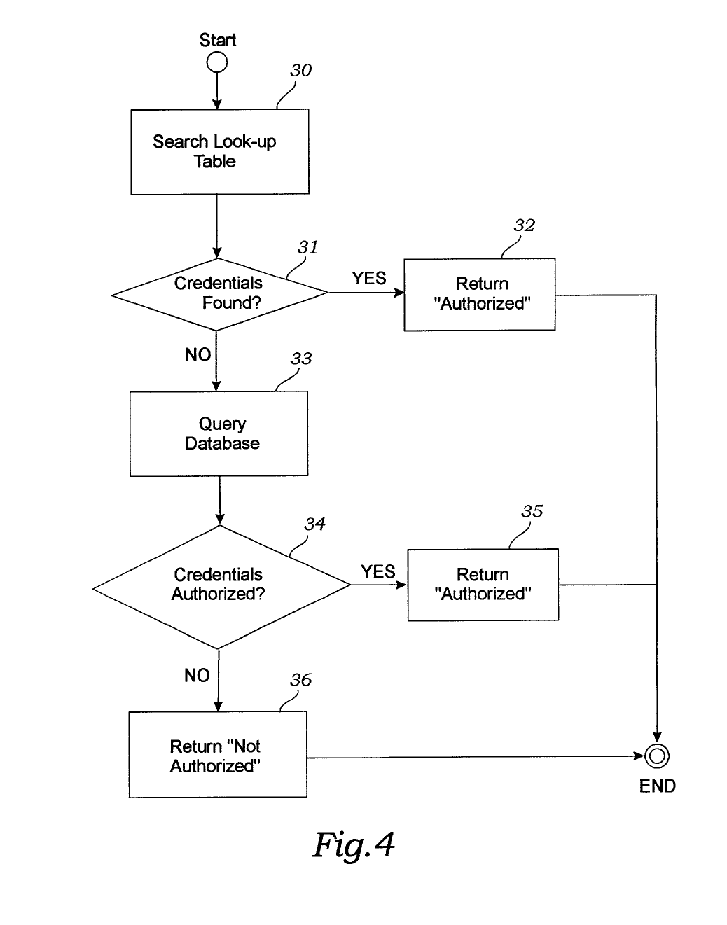

The preferred embodiment of the authorization procedure for the user request is shown in FIG. 4. The proxy 200 searches the credentials lookup table. If the given credentials are found, the procedure returns “authorized”. Otherwise, the proxy 200 queries the database. If the user credentials are found in the database 250 and the user is authorized, the procedure returns “authorized”. Otherwise, the procedure returns “not authorized.”

Please notice, that Steps 30 and 31 in FIG. 4, i.e., searching the lookup table, can be omitted. Also, it is not necessary to receive authorization in every client request. After one request is successfully authorized, the proxy preferably stores the client's IP address in memory and allows all requests from this address, only asking for the credentials again after expiration of a predetermined arbitrary period of time.

This embodiment is especially effective for a service, in which at least some of the users are paying subscribers. In this case, a subscriber gains access, immediately after payment. But if a subscriber has unsubscribed, thereby being removed from the database, he or she still has access for a short period of time, before the credentials lookup table is updated. This does no harm.

In order to collect statistics or to implement caching, the proxy 200 stores the data requests in its permanent memory 202 or may transmit them to another computer over a network, or may process them and store results of such processing in a database. If it is desirable to enhance privacy, the proxy 200 preferably removes user identifying information from the requests after authorization but before storing, transmitting or processing (step 21 of FIG. 3).

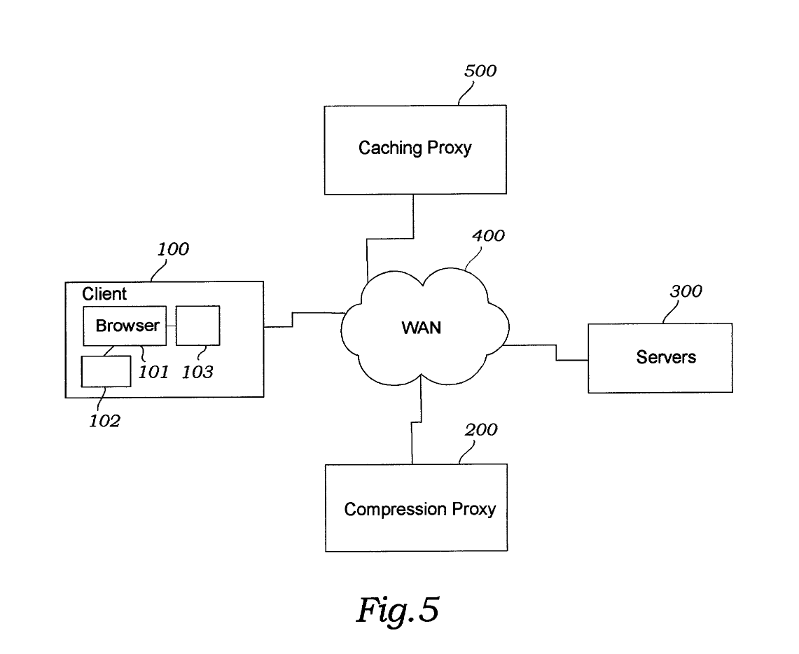

Further, a client 100 is preferably configured in such a way, that the data requests it issues, are routed to different proxies 200 depending on the type of request. Such a system is shown in FIG. 5. The client computer system 100, comprising the browser 101, is connected to the WAN 400. The client 100 comprises a decompression module 102 for certain compressed data formats, which are preferrably a part of the browser 101. In some embodiments, the client 100 comprises additional software module 103, containing a means for transformation of the data requests from and responses to the browser 101. Such transformation functions include decompressing response data, attaching credentials and requesting routing. The proxy computer system 200 is connected to WAN 400. At least one caching proxy 500 is connected to WAN 400 also. In the caching proxy 500, the software caching proxy/server Squid™ is preferably used as installed on a IBM PC compatible Linux computer. The source code of Squid can be obtained without charge from www.squid-cache.org. There is a plurality of servers 300, connected to WAN 400 and which are capable of responding to the data requests.

This system operates in such a way, that the data requests, the responses to which are preferably effectively compressed, significantly decreasing their size, are routed to the compression proxy 200. Other requests are routed to the caching proxy 500 or directly to the server 300. The caching proxy 500 may be established by the Internet Service Provider, serving a particular user, while the compression proxy 200 is established by an independent service provider.

This routing may be implemented through the instructions in a proxy autoconfiguration file of the client's browser 102. The client can recognize the data requests that bring web pages. For example, the requests ending with “.htm,” “.html,” “.asp,” “.css,” “.txt,” “.xml,” “/” or having question mark “?” and not containing “.gif” or “.jpg” are routed to the compression proxy 200. Typically, most of such requests bring web pages or text files. Other files are routed to the caching proxy 200 or directly to the Internet. This allows the combined advantages of data compression and local proxy caching. In another embodiment, the routing may be implemented in the optional software module 103.

The above description is further more specifically described in the following. The invention computer system apparatus comprises a client computer 100 providing a browser 101 and a decompression module 102. At least one compression proxy 200 comprises a CPU 201, a memory means 202, means for sending requests 205, means for receiving requests 203, means for sending data 204, means for receiving data 206, and a data compression means 103. The client computer 100, compression proxy 200 and a server 300 are interconnected through a wide area network, such as the Internet, and the compression proxy 200 is further interconnected to a user database 250. The interconnections may be by transmission wires or wireless as desired and well known.

The client computer 100 further comprises a software module 103 providing a information transformation capability. The compression proxy 200 further comprises a credentials lookup table, as is well known. A caching proxy 500 is employed as described below and shown in FIG. 5.

A computer system method employs the above system comprising the steps of: receiving requests for data from a client computer; checking authorization of the requests for data; rejecting unauthorized requests for data; sending authorized requests for data to a server; receiving data from the server; checking if the data are suitable for compression; sending unsuitable data to the client computer; compressing data suitable for compression; sending compressed data to the client computer. The method further comprises the steps of changing the requests for data according to an HTTP requirement, providing a credentials field and a user field in each of a plurality of database records, performing the operations of adding a user, deleting a user, and looking up credentials, on the database records, setting client credentials in a proxy-authorization field of the database records in response to an HTTP requirement, establishing the client credentials in a memory means, establishing lookup table priority only when the client computer is not found in a credentials lookup table.

Further, the computer system method preferably comprises the steps of searching a credentials lookup table for a client computer; authorizing the client computer if credentials of the client computer are found in the credentials lookup table; searching a database for the client computer if the client computer is not found in the credentials lookup table; authorizing the client computer if the client computer is found in the database and the client computer has approved credentials; rejecting the client computer if the client computer is not found in the lookup table nor in the database; storing an IP address of the client computer if the client computer is authorized; allowing all requests from the stored IP address for a selected period of time; and renewing credentials after the selected period of time has elapsed.

Further, the steps of routing data requests to a plurality of proxys depending on type of request, providing a caching proxy for receiving client computer requests, establishing the caching proxy by an internet service provider (ISP) or on an network of the ISP, establishing the compression proxy, implementing data routing through instructions in a proxy autoconfiguration file of a client browser and implementing routing through a software module provide for a significant improvement over known methods.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A computer system apparatus comprising: a client computer providing a browser and a decompression module; at least one compression proxy comprising a CPU, a memory means, means for sending requests, means for receiving requests, means for sending data, means for receiving data, and data compression means; and a server; the client computer, compression proxy and server, interconnected through a wide area network; the compression proxy further interconnected to a user database.

2. The apparatus of claim 1 wherein the client computer further comprises a software module providing a transformation means.

3. The apparatus of claim 1 further comprising a caching proxy.

4. A computer system method comprising the steps of: receiving requests for data from a client computer; checking authorization of the requests for data; rejecting unauthorized requests for data; sending authorized requests for data to a server; receiving data from the server; checking if the data are suitable for compression; sending unsuitable data to the client computer; compressing data suitable for compression; sending compressed data to the client computer.

5. The method according to claim 4 further comprising the step of changing the requests for data according to an HTTP requirement.

6. The method according to claim 4 further comprising the step of providing a credentials field and a user field in each of a plurality of database records.

7. The method according to claim 6 further comprising the step of performing the operations of adding a user, deleting a user, and looking up credentials, on the database records.

8. The method according to claim 6 further comprising the step of setting client credentials in a proxy-authorization field of a HTTP request.

9. The method of claim 4 further comprising the step of using a lossless compression method.

10. The method of claim 4 further comprising the step of increasing a maximum number of connections allowed between the client computer and the proxy computer.

11. The method of claim 4 further comprising the step of using a file extension of a requested URL in determining a destination of a data request.

12. The method of claim 4 further comprising the step of connecting the client computer through one of a dial up network and a wireless network.

13. A computer system method comprising the steps of: searching a credentials lookup table for a client computer; authorizing the client computer if credentials of the client computer are found in the credentials lookup table; searching a database for the client computer if the client computer is not found in the credentials lookup table; authorizing the client computer if the client computer is found in the database and the client computer has approved credentials; rejecting the client computer if the client computer is not found in the lookup table nor in the database; storing an IP address of the client computer if the client computer is authorized; allowing all requests from the stored IP address for a selected period of time; and renewing credentials after the selected period of time has elapsed.
